(19) United States
(12) Patent Application Publication
(10) Pub. No.: US 2019/0036157 A1
(43) Pub. Date: Jan. 31, 2019

(54) ALL-SOLID-STATE BATTERY, HYBRID-STRUCTURED SOLID ELECTROLYTE MEMBRANE AND MANUFACTURING METHODS THEREOF

(71) Applicant: Institute of Nuclear Energy Research, Atomic Energy Council, Executive Yuan, R.O.C., Taoyuan (TW)

(72) Inventors: Chi-Hung Su, Taoyuan (TW); Chao-Yen Kuo, Taoyuan (TW); Der-Jun Jan, Taoyuan (TW)

(21) Appl. No.: 15/818,969

(22) Filed: Nov. 21, 2017

(30) Foreign Application Priority Data
Jul. 25, 2017 (TW) 106124942

(51) Int. Cl. H01M 10/0562; H01M 10/0525; H01M 10/0565; H01M 10/058

(52) U.S. Cl. CPC H01M 10/0562; H01M 10/0525; H01M 10/0565; H01M 2300/0082; H01M 2300/0091; H01M 2300/0068; H01M 10/058

(57) ABSTRACT

A method for manufacturing a hybrid-structured solid electrolyte membrane includes a step of preparing a liquid solution formed by heating and mixing an electrolytic solution and a lithium salt, a step of mixing orderly a first monomer and then a second monomer into the liquid solution so as to form a hybrid structure, and a step of curing the hybrid structure so as to form a hybrid-structured solid electrolyte membrane. In addition, a hybrid-structured solid electrolyte membrane, an all-solid-state battery and a method for manufacturing the all-solid-state battery are also provided.

### CROSS REFERENCE TO RELATED APPLICATION

This application claims the benefit of Taiwan Patent Application Serial No. 106124942, filed Jul. 25, 2017, the subject matter of which is incorporated herein by reference.

### BACKGROUND OF THE INVENTION

### (1) Field of the Invention

The invention relates to an all-solid-state battery, a hybrid-structured solid electrolyte membrane and manufacturing methods thereof, and more particularly to the high-capacity all-solid-state battery and hybrid-structured solid electrolyte membrane that can be operated normally at room temperature, and also more particularly to the respective methods for manufacturing the aforesaid all-solid-state battery and hybrid-structured solid electrolyte membrane.

### (2) Description of the Prior Art

Among booming developments in mobile devices, a battery with high capacity and rapid charging/discharging ability becomes a necessity for ordinary people. To meet the rising market demand in such a battery and to quickly increase the market share, manufacturers are usually devoted to mass production of new batteries without sufficient safety concerns. Therefrom, new batteries may be carelessly provided with potential or unexpected defects. Recently, for example, a major cause related to several explosive accidents of mobile phones of some world-renowned manufacturers is believed to result from the no-good batteries. In addition, since recent emerge of electric vehicles using new energies, particularly the lithium batteries, usage safety is one of the topics to be concerned urgently. By having the lithium battery as a typical example, frequent occurrence of some battery-related explosive accidents would definitely shadow this industry. Thereupon, huge efforts from related enterprises, research institutes and universities have been devoted to resolve this terrible problem to the industry of lithium batteries. Among all these efforts, an introduction of all-solid-state lithium batteries does present a new hope and a new methodology for resolving that terrible problem.

In the art, the all-solid-state lithium battery is a lithium-ion secondary battery made up by all solid-substance components, including the electrolyte, the positive and negative electrodes. The work theory of the all-solid-state lithium battery is resembled largely to that of the conventional liquid-electrolyte lithium-ion battery. Currently, various compositions for producing the all-solid-state lithium battery are provided already in the art. However, two major shortcomings as follows do still bother the industry of the all-solid-state battery. One of these two shortcomings is that ion conductivity of the solid electrolyte for the current all-solid-state battery is not sufficient at room temperature. Another one is that interface impedance between the solid electrolyte and the positive or negative electrode is too high. Actually, all current solid electrolytes in the marketplace, such as polymer electrolytes, oxide electrolytes, sulfate electrolytes and the like do exist the aforementioned shortcomings. Practically, the polymer is featured in poor temperature resistance, a narrower electrochemical window, poor stability and lower ion conductivity, though having a considerable lower interface impedance. On the other hand, the oxide has a greater interface impedance and a lower ion conductivity. In addition, the sulfate has a higher ion conductivity, a poor interface ion-transport property, and less material stability. Thus, it is obvious that the all-solid-state battery of any of the foregoing three types cannot perform satisfied charging/discharging processes at room temperature.

In the art, some manufacturers do provide an all-solid-state lithium battery with a solid electrolyte. Practically, the solid electrolyte of the current all-solid-state lithium battery can only be operated within a pretty limited range, and thus an additional heating device is usually necessary to heat up the battery to 80° C. so as to reach a startup temperature of the battery (for the conductivity of the battery would be improved after the temperature is risen). However, the process to raise the temperature of the battery is cumbersome, and definitely would consume additional energy, by which the effective energy density of the entire battery pack would be significantly reduced. In particular, since the polymer solid battery has a poor power performance, so a super capacitor with a high power property is necessary while in applying this battery.

Thus, to resolve the aforesaid two major shortcomings in this industry, the topic of providing a new all-solid-state battery with higher capacity and an accompanying method for producing the same battery is definitely welcome and crucial to the art.

### SUMMARY OF THE INVENTION

Accordingly, it is an object of the present invention to provide a method for manufacturing a hybrid-structured solid electrolyte membrane, in which the hybrid-structured solid electrolyte membrane is formed by mixing an organic-polymer solid electrolyte and an inorganic-ceramic solid electrolyte. Also, the aforesaid method can quickly produce the membrane with stable and satisfied quality, and thus can be easily applied for scale-up production.

It is another object of the present invention to provide a hybrid-structured solid electrolyte membrane, that can enhance the ion conductivity of the organic-polymer solid electrolyte, and can also provide higher safety simultaneously, which is mainly contributed by the inorganic-ceramic solid electrolyte.

It is a further object of the present invention to provide a method for manufacturing an all-solid-state battery, from which the resulted battery is featured in usage safety and a high energy density. By having the resulted hybrid-structured solid electrolyte membrane to replace both an isolating film and a liquid electrolyte in the conventional lithium battery, cost for manufacturing the battery can be greatly reduced. Also, since the hybrid-structured solid electrolyte membrane produced by the aforesaid method of the present invention can be directly adhered to, and thus sandwiched between, the positive electrode and the negative electrode, so the assembling of the all-solid-state battery can be much simplified.

It is one more object of the present invention to provide an all-solid-state battery, that can perform charging and discharging normally even at room temperature, and that can effectively lower the interface impedance between the hybrid-structured solid electrolyte membrane and any of the positive and negative electrodes.

In the present invention, the method for manufacturing a hybrid-structured solid electrolyte membrane includes the steps of: (a) preparing a liquid solution, the liquid solution being formed by heating and mixing an electrolytic solution and a lithium salt; (b) mixing orderly a first monomer and then a second monomer into the liquid solution so as to form a hybrid structure; and, (c) curing the hybrid structure so as to form a hybrid-structured solid electrolyte membrane.

In one embodiment of the present invention, the hybrid structure is a solid-colloidal hybrid structure, the first monomer is a liquid or colloidal solution, and the second monomer is a solid substance.

In one embodiment of the present invention, the solid substance is in a form of powder, layer or chip.

In one embodiment of the present invention, the first monomer is a thermoplastic polymer, the second monomer is an inorganic electrolyte, a solid electrolyte or an inorganic solid electrolyte, the hybrid structure is formed by a thermal coating technique, and the thermal coating technique includes the steps of: (b11) providing the thermoplastic polymer; (b12) adding the thermoplastic polymer into the liquid solution, a weight percentage of the thermoplastic polymer in the liquid solution being 1%˜80%; (b13) heating the liquid solution to dissolve the thermoplastic polymer into the liquid solution so as to form a colloidal solution; and, (b14) mixing the second monomer into the colloidal solution so as to form the hybrid structure, a weight percentage of the second monomer in the colloidal solution being 1%˜98%.

In one embodiment of the present invention, the aforesaid step (c) is a cooling process.

In one embodiment of the present invention, the first monomer is a UV light-curing polymer, the second monomer is an inorganic electrolyte, a solid electrolyte or an inorganic solid electrolyte, the hybrid structure is formed by a light-curing technique, and the light-curing technique includes the steps of: (b21) providing the UV light-curing polymer; (b22) adding the UV light-curing polymer into the liquid solution so as to form a mixed solution, a weight percentage of the UV light-curing polymer in the liquid solution being 1%˜80%; and, (b23) mixing the second monomer into the mixed solution, a weight percentage of the second monomer in the mixed solution being 1%˜98%.

In one embodiment of the present invention, the aforesaid step (c) is a UV light-curing process.

In one embodiment of the present invention, the electrolytic solution is selected from the group of Ethylene carbonate, Polypropylene carbonate, Dimethoxyethane, Dimethyl carbonate, Ethyl methyl carbonate, Sulfolane and Succinonitirle.

In one embodiment of the present invention, the lithium salt is selected from the group of LiPF₆, LiClO₄ and LiN(SO₂CF3)₂, a concentration of the lithium salt in the liquid solution being 1M.

In one embodiment of the present invention, the second monomer is selected from the group of La_{0.51}Li_{0.34}TiO₂ (LLTO), Li₇La₃Zr₂O₁₂ (LLZO), Li₃A1_{0.3}Ti₇(PO₄)₃ (LATP), LU_{n1-X}Ge₀₄(LISI₍₃₎N), Li₂S, Li₂S—P₂S₅̂Li₂S—SiS₂′Li₂S—GeS₂′Li₂S—B₂S₅̂Li₂S—Al₂S₅̂Li_{3.25}Ge_{0.25}P_{0.75}S₄ (Thio-LISICON), Li₃N and Li_{3+y}POO₄₋ₓNₓ (LIPON).

In the present invention, the hybrid-structured solid electrolyte membrane produced by the aforesaid method for manufacturing a hybrid-structured solid electrolyte membrane is provided.

In the present invention, the method for manufacturing an all-solid-state battery includes the steps of: (1) preparing a hybrid-structured solid electrolyte membrane, the hybrid-structured solid electrolyte membrane being manufactured by the aforesaid method; and, (2) performing an adhering process to adhere a first electrode and a second electrode respectively to two opposing sides of the hybrid-structured solid electrolyte membrane, the first electrode and the second electrode being opposite-charged electrodes.

In the present invention, the all-solid-state battery includes a hybrid-structured solid electrolyte membrane, and a first electrode and a second electrode. The hybrid-structured solid electrolyte membrane, formed by curing a hybrid structure, includes a first monomer and a second monomer. The hybrid structure is firstly formed by orderly adding the first monomer and then the second monomer into a liquid solution. The liquid solution is formed by heating and mixing an electrolytic solution and a lithium salt. The first electrode and the second electrode are adhered respectively to two opposing sides of the solid electrolyte membrane, and the first electrode and the second electrode are opposite-charged electrodes.

In one embodiment of the present invention, the hybrid structure is an organic-inorganic hybrid structure, the first monomer is an organic substance, and the second monomer is an inorganic substance.

In one embodiment of the present invention, the hybrid structure is a solid-colloidal hybrid structure, the first monomer is a liquid or colloidal solution, and the second monomer is a solid substance.

In one embodiment of the present invention, is in a form of powder, layer or chip.

In one embodiment of the present invention, the first monomer is a thermoplastic polymer or a UV light-curing polymer.

In one embodiment of the present invention, the second monomer is an inorganic electrolyte, a solid electrolyte or an inorganic solid electrolyte.

In one embodiment of the present invention, each of the first electrode and the second electrode includes a collector layer and an active substance.

As mentioned, in the all-solid-state battery, the hybrid-structured solid electrolyte membrane and the methods for manufacturing the aforesaid two according to the present invention, the hybrid-structured solid electrolyte membrane can not only provide superior ion conductivity of 1×10⁻⁴S/cm, but can also effectively impede the positive and negative electrodes of the all-solid-state battery. Hence, it is clear that the all-solid-state battery with the hybrid-structured solid electrolyte membrane of the present invention can substitute completely the conventional lithium battery with the isolating film and the liquid electrolyte. Namely, the hybrid-structured solid electrolyte membrane provided by the present invention can exhibit properties of both the isolating film and the electrolytic layer, and thus can reduce the manufacturing cost of the battery effectively.

Further, the hybrid-structured solid electrolyte membrane of the present invention can provide satisfied electrochemical properties, such as well thermodynamic stability and a wider electrochemical window; and thus the conventional shortcomings in usage safety and high-voltage performance of the liquid electrolyte can be substantially resolved. Also, the hybrid-structured solid electrolyte membrane of the present invention can enhance the ion conductivity, and thus the shortcoming of the conventional solid electrolyte of the inorganic ceramic material in low ion conductivity can be substantially resolved. Hence, through the inorganic solid electrolyte with higher ion conductivity in accordance with the present invention, a fluent path for the lithium ion to transport easily is thus established, such that the resulted all-solid-state battery can perform charging and discharging normally even at room temperature.

In addition, the soften organic polymer provided by the present invention can make the contact between the positive or negative electrode and the solid electrolyte much tighter and closer, so that the interface impedance between the solid electrolyte and the positive or negative electrode can be substantially decreased.

Furthermore, the hybrid-structured solid electrolyte membrane is formed by mixing the inorganic solid electrolyte and the organic polymer. Thus, except that the ion conductivity of the organic-polymer solid electrolyte can be increased, also higher safety contributed by the inorganic-ceramic solid electrolyte can be obtained at the same time.

All these objects are achieved by the all-solid-state battery, the hybrid-structured solid electrolyte membrane and the manufacturing methods thereof described below.

### BRIEF DESCRIPTION OF THE DRAWINGS

The present invention will now be specified with reference to its preferred embodiment illustrated in the drawings, in which:

FIG. 1 is a flowchart of a preferred method for manufacturing an all-solid-state battery in accordance with the present invention;

FIG. 2 is a flowchart of a preferred method for manufacturing a hybrid-structured solid electrolyte membrane in accordance with the present invention;

FIG. 3 is a flowchart of an embodiment of the method for manufacturing a hybrid structure in accordance with the present invention;

FIG. 4 is a flowchart of another embodiment of the method for manufacturing a hybrid structure in accordance with the present invention;

FIG. 5 is a schematic view of a preferred all-solid-state battery in accordance with the present invention;

FIG. 6 is a plot of a charging/discharging test by having an organic polymer electrolyte as a component of a conventional all-solid-state battery; and

FIG. 7 is a plot of a charging/discharging test by having the hybrid-structured solid electrolyte membrane as a component of the all-solid-state battery in accordance with the present invention.

### DESCRIPTION OF THE PREFERRED EMBODIMENT

The invention disclosed herein is directed to an all-solid-state battery, a hybrid-structured solid electrolyte membrane and manufacturing methods thereof. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

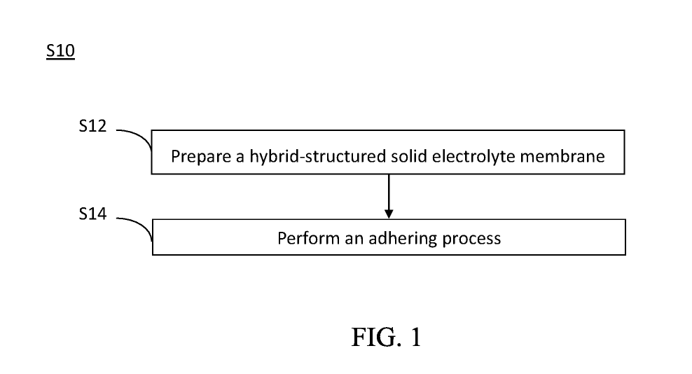

Referring now to FIG. 1, a flowchart of a preferred method for manufacturing an all-solid-state battery in accordance with the present invention is shown.

The method for manufacturing an all-solid-state battery S10 includes Steps S12 and S14.

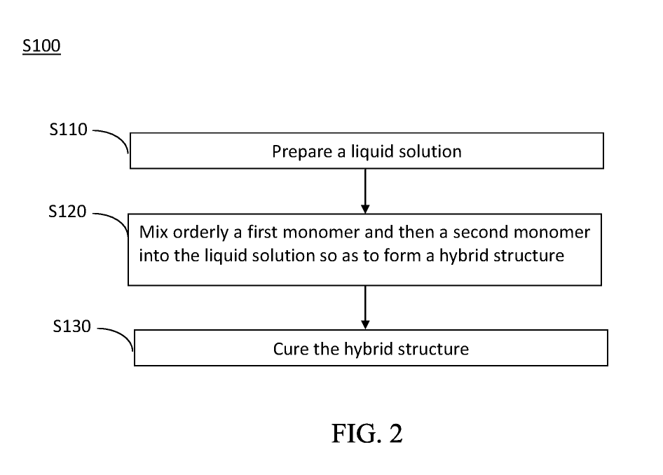

Firstly, Step S12 is performed to prepare a hybrid-structured solid electrolyte membrane. Detailedly, referring now to FIG. 2, a flowchart of a preferred method for manufacturing the hybrid-structured solid electrolyte membrane in accordance with the present invention is shown. The method for manufacturing the hybrid-structured solid electrolyte membrane S100 includes Steps S110˜S130.

While in performing Step S110, a liquid solution is prepared. The liquid solution is formed by heating and mixing an electrolytic solution and a lithium salt.

In one exemplary example, the electrolytic solution and the lithium salt are heated and mixed to form a liquid solution by a heating mantle and a mechanical stirrer. The lithium salt is dissolved into the electrolytic solution so as to produce the liquid solution having a specific concentration, 1M for example. In addition, exact contents of the lithium salt and the electrolytic solution in the liquid solution are determined upon practical requirements.

In this embodiment, the electrolytic solution can be selected from the group of Ethylene carbonate, Polypropylene carbonate, Sulfolane and Succinonitirle. Further, the choice of the electrolytic solution can be determined by evaluating practical needs.

In this embodiment, the lithium salt can be selected from the group of LiPF₆, LiClO₄ and LiN(SO₂CF₃)₂. Also, the choice of the lithium salt can be determined by evaluating practical needs.

While in performing Step S120, a first monomer and a second monomer are orderly mixed into the liquid solution so as to form a hybrid structure.

It shall be explained that, in one embodiment of the present invention, the first monomer is an organic substance, and the second monomer is an inorganic substance. Namely, the hybrid structure of the present invention can be an organic-inorganic hybrid structure. However, in another embodiment, the first monomer is a liquid solution or a colloidal solution, and the second monomer is a solid substance in a form of powder, layer, chip or any the like. Namely, the hybrid structure can be a solid-and-gel hybrid structure.

In this embodiment, the second monomer can be an inorganic solid electrolyte selected from the group of La_{0.51}Li_{0.34}TiO₂ (LLTO), Li₇La₃Zr₂O₁₂ (LLZO), Li₃A1_{0.3}Ti₇(PO₄)₃ (LATP), LUₙ₁₋ₓGe₀₄(LISI₍₃₎N), Li₂S, Li₂S—P₂S₅̂Li₂S—SiS₂′Li₂S—GeS₂′Li₂S—B₂S₅̂Li₂S—Al₂S₅̂Li_{3.25}Ge_{0.25}P_{0.75}S₄ (Thio-LISICON), Li₃N and Li_{3+y}PO₄₋ₓNₓ (LIPON). The choice of the inorganic solid electrolyte can be determined by evaluating practical needs.

In addition, in one embodiment of the present invention, the second monomer is a powder of an inorganic solid electrolyte, where the powder of the inorganic solid electrolyte has a granular diameter ranging approximately from 10 nm to 2000 nm and can be spherically, elliptically or any irregularly shaped. In another embodiment, the second monomer is a block-shaped or layer-shaped inorganic solid electrolyte having a thickness ranging between 0.01 mm and 1 mm and formed by compressing or heating. Though the second monomer can be an inorganic electrolyte or a solid electrolyte, yet the material choice for the second monomer electrolytic solution is preferably determined by evaluating practical needs.

In this embodiment, the first monomer can be a thermoplastic polymer, a thermosetting polymer, a UV light-curing polymer or a polymer host formed by copolymers of the foregoing polymers. However, the material choice for the first monomer is preferably determined by evaluating practical needs. In this embodiment, the material for the first monomer is selected to produce the hybrid structure by a thermal coating technique or a light-curing technique.

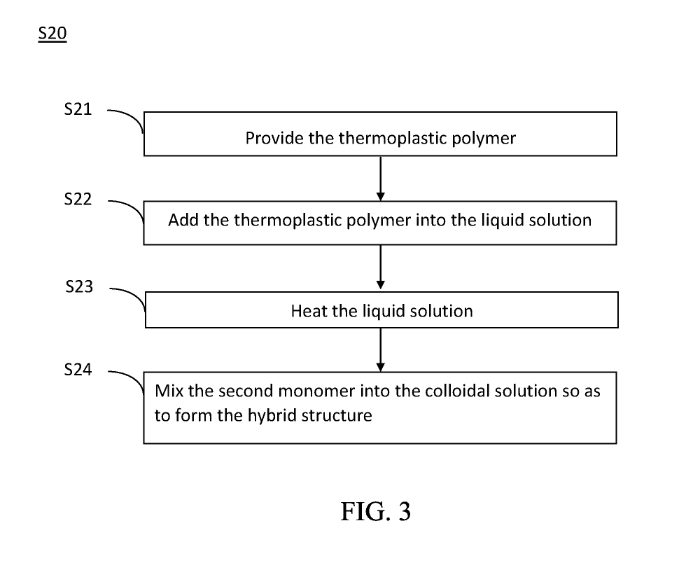

By having the thermal coating technique as an example, and referring now to FIG. 3, a flowchart of an embodiment of the method for manufacturing a hybrid structure in accordance with the present invention is shown. The method for manufacturing a hybrid structure S20 includes Steps S21˜S24 as follows.

While in performing Step S21, a thermoplastic polymer is firstly provided.

The thermoplastic polymer is a plastic material that is softened after being heated, cured after being cooled down, and can be softened again after another heating. Namely, the thermoplastic polymer is moldable after being heated into a liquid state, and becomes solid after being cooled down. In this embodiment, the thermoplastic polymer can be PEO, PVDF, Polyacrylonitrile, Methyl methacrylate (MMA), Polyvinylidene fluoride, a copolymer of poly(Vinylidene fluoride-hexafluoropropylene), or any the like. In practice, the choice of the thermoplastic material is preferably determined to meet requirements of the thermal coating technique for the method of the present invention.

While in performing Step S22, the selected thermoplastic polymer is added into the liquid solution. In one exemplary example of the present invention, the weight percentage of the thermoplastic polymer in the liquid solution is about 1%˜80%. A preferred weight percentage of the thermoplastic polymer in the liquid solution can be determined by evaluating practical requirements.

While in performing Step S23, the liquid solution is heated to dissolve the thermoplastic polymer into the liquid solution so as thereby to form a colloidal solution.

In one embodiment of the present invention, the thermoplastic polymer is kept adding into the liquid solution, and the liquid solution is heated and stirred under a temperature range of 50° C.˜150° C., such that the thermoplastic polymer can dissolve homogeneously in the liquid solution. Meanwhile, the heated and stirred liquid solution would gradually form a colloidal solution. It shall be explained that the aforesaid temperature range can be adjusted upon various formulations of the liquid solution and different requirements in solution properties such as the viscosity.

While in performing Step S24, the second monomer is mixed into the colloidal solution so as thereby to form a hybrid structure. In this embodiment, the weight percentage of the second monomer in the colloidal solution is about 1%˜98%. After the aforesaid Step S21˜Step S24 are finished, a thermal coating technique can be applied to form the hybrid structure. In addition, the aforesaid first monomer can be selected as an organic substance with thermoplasticity, such as a thermoplastic organic polymer; while the second monomer can be selected as an inorganic solid electrolyte, such as an inorganic-ceramic solid electrolyte. Thereupon, the hybrid structure can be formed as an organic-inorganic hybrid structure. Alternatives, the aforesaid first monomer can be a thermoplastic material, which is used to form the liquid or colloidal solution after being heated; while the second monomer can be selected to be a solid substance, such as a solid electrolyte. Thereupon, the hybrid structure can be formed as a solid-colloidal hybrid structure. To have an organic-inorganic hybrid structure or a solid-colloidal hybrid structure is up to practical requirements of the manufacturing.

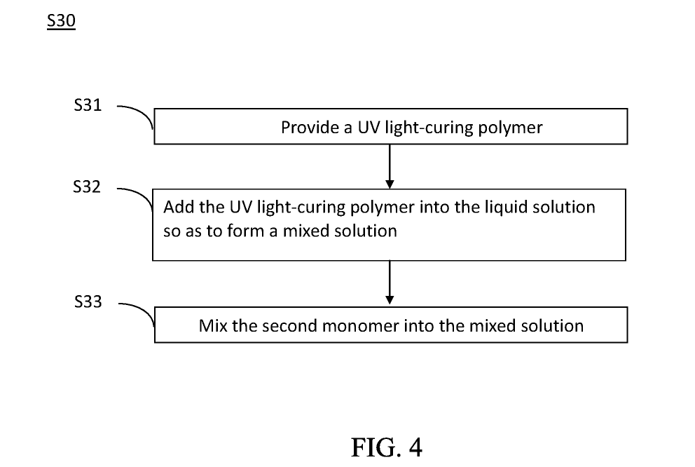

By having a light-curing technique as another example, the first monomer is a UV light-curing polymer, while the second monomer is an inorganic electrolyte, a solid electrolyte or an inorganic solid electrolyte. Referring now to FIG. 4, a flowchart of another embodiment of the method for manufacturing a hybrid structure in accordance with the present invention is shown. The method for manufacturing a hybrid structure S30 includes Steps S31˜S33 as follows.

While in performing Step S31, a UV light-curing polymer is provided.

The UV light-curing polymer is a polymer that can be cured by projecting a UV light. In this embodiment, the UV light-curing polymer can be a polymer of Acrylic-easter base, Trimethylolpropane triacrylate, Vinyl base, Non-vinyl base, Ethoxylated trimethylolpropane triacrylate (ETPTA) and any the like that can be cured by the UV light.

While in performing Step S32, the UV light-curing polymer is added into the liquid solution so as to form a mixed solution.

In one exemplary example, in weight percentages, a ratio of the liquid solution to the UV light-curing polymer is (1 1wt %˜99 wt %) (99 wt %˜1 wt %) for forming the mixed solution. In another exemplary example, the weight percentage of the UV light-curing polymer in the liquid solution is 1%˜80%.

While in performing Step S33, the second monomer is mixed into the mixed solution, where the weight percentage of the second monomer in the mixed solution is 1%˜98%. In addition, the aforesaid first monomer can be selected to be a UV light-curing organic substance, while the second monomer is selected to be an inorganic solid electrolyte. Thereupon, the hybrid structure is thus formed as an organic-inorganic hybrid structure. Alternatively, the aforesaid first monomer can be selected to be a UV light-curing substance in a liquid or colloidal solution, while the second monomer is selected to be a solid substance, such as a solid electrolyte. Thereupon, the hybrid structure is thus formed as a solid-colloidal hybrid structure. To have an organic-inorganic hybrid structure or a solid-colloidal hybrid structure is up to practical requirements of the manufacturing.

After having the hybrid structure formed by any of the aforesaid techniques, refer back to FIG. 2 to perform Step S130. In Step S130, the hybrid structure is cured to form a hybrid-structured solid electrolyte membrane.

By having the hybrid structure produced by the thermal coating technique of FIG. 3 as an example, the curing of the hybrid structure is a cooling process. Namely, in one exemplary example, the hybrid structure, obtained after performing Step S21˜Step S24, can be painted onto a release paper by a painting scraper. After the hybrid structure is cooled down, the hybrid-structured solid electrolyte membrane is then formed. In the following steps, a vacuuming process can be applied to dehydrate, and then the hybrid-structured solid electrolyte membrane is stored in an inert environment so as to expel oxygen in the hybrid-structured solid electrolyte membrane. Of course, the following processes are subject to change according to practical requirements.

By having the hybrid structure produced by the thermal coating technique of FIG. 4 as an example, the curing of the hybrid structure is a UV light-curing process. Namely, in one exemplary example, the hybrid structure, obtained after performing Step S31˜Step S33, can be cured and polymerized by projecting the UV light for about 20 seconds so as to form a hybrid-structured solid electrolyte membrane.

Referring now back to FIG. 1, then Step S14 is performed to carry out an adhering process.

In the aforesaid adhering process, a first electrode and a second electrode are individually adhered respectively to two opposing sides of the hybrid-structured solid electrolyte membrane, in which the first electrode and the second electrode are opposite-charged electrodes. Also, in the adhering process, according to practical needs, the aforesaid hybrid-structured solid electrolyte membrane can be tailored into pieces with different sizes and shapes, such that the all-solid-state battery can be produced in arbitrary dimensions.

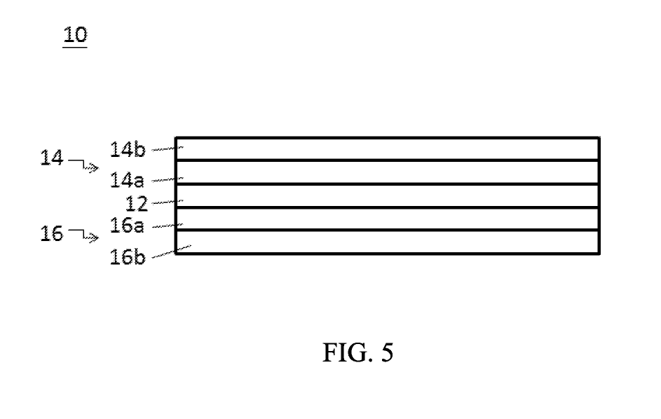

Referring now to FIG. 5, a schematic view of a preferred all-solid-state battery in accordance with the present invention is shown. The all-solid-state battery 10 includes a hybrid-structured solid electrolyte membrane 12, a first electrode 14 and a second electrode 16. The method for manufacturing the hybrid-structured solid electrolyte membrane 12 can be referred to FIG. 2 through FIG. 4, and thus details thereabout would be omitted herein.

The first electrode 14 and the second electrode 16 are opposite-charged electrodes. For example, the first electrode 14 can be a positive electrode, while the second electrode 16 is a negative electrode. In this embodiment, the first electrode 14 and the second electrode 16 are structured by respective composite electrodes. As shown, each of the first electrode 14 and the second electrode 16 includes individually an active substance 14a or 16a, a collector layer 14b or 16b, a conductor, an adhesive and particles of inorganic solid electrolyte. Namely, the first electrode 14 and the second electrode 16 can be formed from a mixture consisted of particles of active positive-electrode or negative-electrode substances that are to be deposited in the corresponding electrodes, conducting materials (carbon conductors for example) and adhesives, mixed completely by a predetermined ratio.

In one embodiment, a ratio, in weight percentage, of the particles of active positive-electrode or negative-electrode substances, the conducting materials (carbon conductors for example) and the adhesives can be (90 wt %˜99 wt %) (0.5 wt %˜5 wt %) (0.5 wt %˜5 wt %), approximately. A relevant ratio of these different components for forming the composite electrode, especially the active positive-electrode and negative-electrode substances, is judged by evaluating if a substantial voltage difference between the positive electrode and the negative electrode does exist.

In this embodiment, the active substances 14a, 16a are used to form the first electrode 14 as the positive electrode and the second electrode 16 as the negative electrode, respectively. Regarding the active substance 14a, as an active positive-electrode substance, the active substance 14a can adopt a lithium cobalt-based compositeoxide, a lithium nickel-based compositeoxide, a lithium manganese-based compositeoxide, a lithium vanadium-based compositeoxide or a lithium Fe-based compositeoxide, and includes a substance that is inserted by lithium or dislodged of lithium electrochemically by an oxidation-reduction reaction. The choice of a relevant active positive-electrode substance is determined upon practical requirements of the manufacturing method. On the other hand, regarding the active substance 16a, as an active negative-electrode substance, the active substance 16a can adopt metal lithium, lithium alloys, hard carbon, soft carbon, Fullerene, Tl2 or SnO₂. The choice of a relevant active negative-electrode substance is determined upon practical requirements of the manufacturing method.

In this embodiment, the collector layers 14b, 16b can be formed by Ag, Cu, Ni, Co, Al, stainless steel, Au, Pt or any conductive material the like. The choice of a relevant material for the collector layer is determined upon practical requirements.

In this embodiment, the conductor can be graphene, carbon nano tubes, Ketjen black, active carbon, Super P, KS6, vapor-grown carbon fiber (VGCF) or a material in a hybrid-fiber form that mixes at least two foregoing materials. Alternatively, the conductor can be any conductive carbon such as the VGCF. Anyway, the choice of a relevant material for the conductor is determined upon practical requirements.

In this embodiment, the adhesive can include PTFE, PVDF, CMC, SBR or a combination of at least one polyimide group. The choice of a relevant material for the adhesive is determined upon practical requirements

In one embodiment, the first electrode 14 and the second electrode 16 can adopt particles of the inorganic solid electrolyte for enhancing the ion conductivity between the electrodes. A material for the particles of the inorganic solid electrolyte can be selected from the group of La_{0.51}Li_{0.34}TiO₂ (LLTO), Li₇La₃Zr₂O₁₂ (LLZO), Li₃A1_{0.3}Ti₇ (PO₄)₃ (LATP), LUₙ₁₋ₓGe₀₄ (LISI₍₃₎N), Li₂S, Li₂S—P₂S₅̂Li₂S—SiS₂′Li₂S—GeS₂′Li₂S—B₂S₅̂Li₂S—Al₂S₅̂Li_{3.25}Ge_{0.25}P_{0.75}S₄ (Thio-LISICON), Li₃N and Li_{3+y}PO₄₋ₓNₓ (LIPON). The choice of a relevant material for the inorganic solid electrolyte is determined upon practical requirements.

In one performance test according to the present invention, about a 1 cm² piece of the hybrid-structured solid electrolyte membrane is prepared. The hybrid-structured solid electrolyte membrane is arranged into a battery shell for examining the alternate impedance of the material. Through the impedance spectrum, it is found that, at room temperature, the conductivity of the hybrid-structured solid electrolyte membrane is 1×10⁻⁴S/cm, and the stable electrochemical window is 5V by applying a stainless steel electrode and a metal lithium electrode. Thus, it is proved that the hybrid-structured solid electrolyte membrane provided by the present invention has at least better thermodynamic stability and a wider electrochemical window. Hence, by sandwiching the hybrid-structured solid electrolyte membrane between the two electrodes so as to form an all-solid-state battery, the resulted all-solid-state battery can perform the charging/discharging normally even at room temperature. In addition, by comparing to the conventional organic polymer electrolyte, the hybrid-structured solid electrolyte membrane provided by the present invention has better ion conductivity and stability.

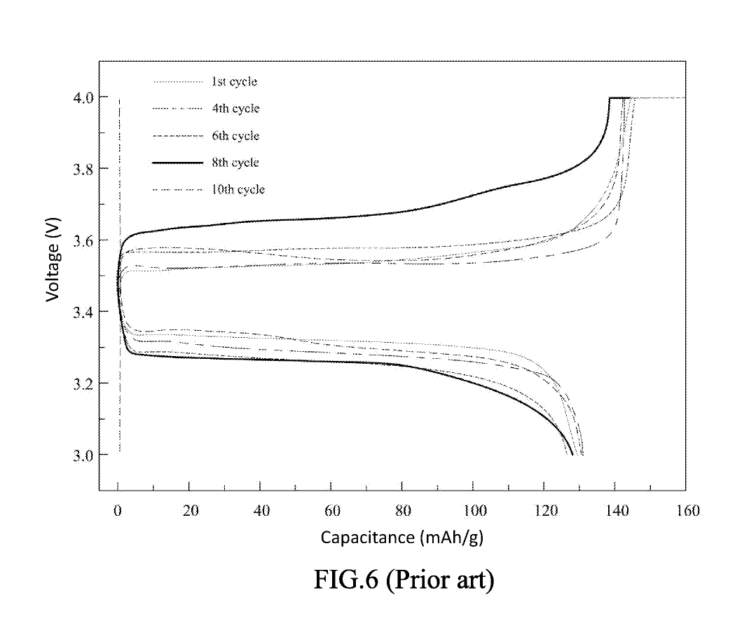

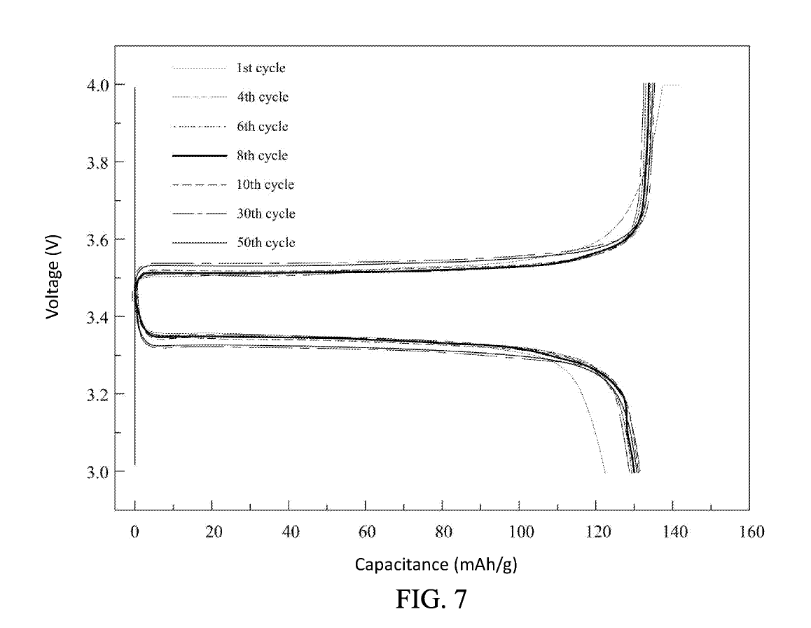

Refer now to FIG. 6 and FIG. 7; where FIG. 6 is a plot of a charging/discharging test by having an organic polymer electrolyte as a component of a conventional all-solid-state battery, and FIG. 7 is a plot of a charging/discharging test by having the hybrid-structured solid electrolyte membrane as a component of the all-solid-state battery in accordance with the present invention. In FIG. 6, LiFePO₂ is adopted to be the organic polymer electrolyte for the lithium battery. On the other hand, in FIG. 7, LiFePO₂ is adopted to be the hybrid-structured solid electrolyte membrane for the lithium battery. By given a 1 cm² electrode area, a 0.2 charge/discharge rate cycle, and about a 130 mAh/g gram capacitance, it is found that the hybrid-structured solid electrolyte membrane provided by the present invention can produce an all-solid-state battery having a lower-degree battery over-voltage. Namely, the all-solid-state battery in accordance with the present invention has lower electric resistance, and, after several cycles of the charging/discharging processes, the all-solid-state battery of the present invention shows better and more stable performance in charging and discharging than that with the organic polymer electrolyte. Apparently, it is proved again that the all-solid-state battery with the hybrid-structured solid electrolyte membrane of the present invention can provide stable charging/discharging performance.

In summary, in the all-solid-state battery, the hybrid-structured solid electrolyte membrane and the methods for manufacturing the aforesaid two according to the present invention, the hybrid-structured solid electrolyte membrane can not only provide superior ion conductivity of 1×10⁻⁴S/cm, but can also effectively impede the positive and negative electrodes of the all-solid-state battery. Hence, it is clear that the all-solid-state battery with the hybrid-structured solid electrolyte membrane of the present invention can substitute completely the conventional lithium battery with the isolating film and the liquid electrolyte. Namely, the hybrid-structured solid electrolyte membrane provided by the present invention can exhibit properties in both the isolating film and the electrolytic layer, and thus can reduce the manufacturing cost of the battery effectively.

Further, the hybrid-structured solid electrolyte membrane of the present invention can provide satisfied electrochemical properties, such as well thermodynamic stability and a wider electrochemical window; and thus the conventional shortcomings in usage safety and high-voltage performance of the liquid electrolyte can be substantially resolved. Also, the hybrid-structured solid electrolyte membrane of the present invention can enhance the ion conductivity, and thus the shortcoming of the conventional solid electrolyte of the inorganic ceramic material in lower ion conductivity can be substantially resolved. Hence, through the inorganic solid electrolyte with higher ion conductivity in accordance with the present invention, a fluent path for the lithium ion easy to transport is thus established, such that the resulted all-solid-state battery can perform charging and discharging normally even at room temperature.

In addition, the soften organic polymer provided by the present invention can make the contact between the positive or negative electrode and the solid electrolyte tighter and closer, so that the interface impedance between the solid electrolyte and the positive or negative electrode can be substantially decreased.

Furthermore, the hybrid-structured solid electrolyte membrane is formed by mixing the inorganic solid electrolyte and the organic polymer. Thus, except that the ion conductivity of the organic-polymer solid electrolyte can be increased, also higher safety contributed by the inorganic-ceramic solid electrolyte can be obtained at the same time.

In addition, in the present invention, since various shapes of the hybrid-structured solid electrolyte membrane can be produced per practical requirements, a manufacturing process in a roll-to-roll manner makes easier the production, superior mechanical properties of the inorganic solid electrolyte can be obtained, and the material used is inflammable and volatile, thus the problems in liquid leakage, poor temperature resistance and other safety issues would not exist any more.

In particular, the hybrid-structured solid electrolyte membrane produced by the aforesaid method of the present invention can be directly adhered to, and thus sandwiched between, the positive electrode and the negative electrode, so that the assembling of the all-solid-state battery can be much simplified.

In addition, since the hybrid-structured solid electrolyte membrane of the present invention is applicable to the all-solid-state film lithium battery featured in a small volume, a high energy density and a long service life, and can be also applied to the electrode of high energy density (such as lithium-rich materials and lithium-sulfur battery materials) for enhancing the energy density of the lithium battery.

While the present invention has been particularly shown and described with reference to a preferred embodiment, it will be understood by those skilled in the art that various changes in form and detail may be without departing from the spirit and scope of the present invention.

What is claimed is:

1. A method for manufacturing a hybrid-structured solid electrolyte membrane, comprising the steps of:
(a) preparing a liquid solution, the liquid solution being formed by heating and mixing an electrolytic solution and a lithium salt;
(b) mixing orderly a first monomer and then a second monomer into the liquid solution so as to form a hybrid structure; and
(c) curing the hybrid structure so as to form a hybrid-structured solid electrolyte membrane.

2. The method for manufacturing a hybrid-structured solid electrolyte membrane of claim 1, wherein the hybrid structure is an organic-inorganic hybrid structure, the first monomer is an organic substance, and the second monomer is an inorganic sub stance.

3. The method for manufacturing a hybrid-structured solid electrolyte membrane of claim 1, wherein the hybrid structure is a solid-colloidal hybrid structure, the first monomer is a liquid or colloidal solution, and the second monomer is a solid sub stance.

4. The method for manufacturing a hybrid-structured solid electrolyte membrane of claim 3, wherein the solid substance is in a form of powder, layer or chip.

5. The method for manufacturing a hybrid-structured solid electrolyte membrane of claim 1, wherein the first monomer is a thermoplastic polymer, the second monomer is an inorganic electrolyte, a solid electrolyte or an inorganic solid electrolyte, the hybrid structure is formed by a thermal coating technique, and the thermal coating technique includes the steps of:
(b11) providing the thermoplastic polymer;
(b12) adding the thermoplastic polymer into the liquid solution, a weight percentage of the thermoplastic polymer in the liquid solution being 1%˜80%;
(b13) heating the liquid solution to dissolve the thermoplastic polymer into the liquid solution so as to form a colloidal solution; and
(b14) mixing the second monomer into the colloidal solution so as to form the hybrid structure, a weight percentage of the second monomer in the colloidal solution being 1%˜98%.

6. The method for manufacturing a hybrid-structured solid electrolyte membrane of claim 5, wherein the step (c) is a cooling process.

7. The method for manufacturing a hybrid-structured solid electrolyte membrane of claim 1, wherein the first monomer is a UV light-curing polymer, the second monomer is an inorganic electrolyte, a solid electrolyte or an inorganic solid electrolyte, the hybrid structure is formed by a light-curing technique, and the light-curing technique includes the steps of:
(b21) providing the UV light-curing polymer;
(b22) adding the UV light-curing polymer into the liquid solution so as to form a mixed solution, a weight percentage of the UV light-curing polymer in the liquid solution being 1%˜80%; and
(b23) mixing the second monomer into the mixed solution, a weight percentage of the second monomer in the mixed solution being 1%˜98%.

8. The method for manufacturing a hybrid-structured solid electrolyte membrane of claim 7, wherein the step (c) is a UV light-curing process.

9. The method for manufacturing a hybrid-structured solid electrolyte membrane of claim 1, wherein the electrolytic solution is selected from the group of Ethylene carbonate, Polypropylene carbonate, Dimethoxyethane, Dimethyl carbonate, Ethyl methyl carbonate, Sulfolane and Succinonitirle.

10. The method for manufacturing a hybrid-structured solid electrolyte membrane of claim 1, wherein the lithium salt is selected from the group of LiPF₆, LiClO₄ and LiN(SO₂CF₃)₂, a concentration of the lithium salt in the liquid solution being 1M.

11. The method for manufacturing a hybrid-structured solid electrolyte membrane of claim 1, wherein the second monomer is selected from the group of La_{0.51}Li_{0.34}TiO₂ (LLTO), Li₇La₃Zr₂O₁₂ (LLZO), Li₃A1_{0.3}Ti₇(PO₄)₃ (LATP), LU_{n1-X}Ge₀₄(LISI₍₃₎N), Li₂S, Li₂S—P₂S₅̂Li₂S—SiS₂′Li₂S—GeS₂′Li₂S—B₂S₅̂Li₂S—Al₂S₅̂Li_{3.25}Ge_{0.25}P_{0.75}S₄ (Thio-LISICON), Li₃N and Li_{3+y}POO₄₋ₓNₓ (LIPON).

12. A hybrid-structured solid electrolyte membrane, manufactured by the method of any of claim 1.

13. A method for manufacturing an all-solid-state battery, comprising the steps of:
(1) preparing a hybrid-structured solid electrolyte membrane, the hybrid-structured solid electrolyte membrane being manufactured by the method of any of claims 1; and
(2) performing an adhering process to adhere a first electrode and a second electrode respectively to two opposing sides of the hybrid-structured solid electrolyte membrane, the first electrode and the second electrode being opposite-charged electrodes.

14. An all-solid-state battery, comprising:
a hybrid-structured solid electrolyte membrane, formed by curing a hybrid structure, the hybrid structure including a first monomer and a second monomer, the hybrid structure being firstly formed by adding orderly the first monomer and then the second monomer into a liquid solution, the liquid solution being formed by heating and mixing an electrolytic solution and a lithium salt; and
a first electrode and a second electrode, adhered respectively to two opposing sides of the solid electrolyte membrane, the first electrode and the second electrode being opposite-charged electrodes.

15. The all-solid-state battery of claim 14, wherein the hybrid structure is an organic-inorganic hybrid structure, the first monomer is an organic substance, and the second monomer is an inorganic substance.

16. The all-solid-state battery of claim 14, wherein the hybrid structure is a solid-colloidal hybrid structure, the first monomer is a liquid or colloidal solution, and the second monomer is a solid substance.

17. The all-solid-state battery of claim 14, wherein the solid substance is in a form of powder, layer or chip.

18. The all-solid-state battery of claim 14, wherein the first monomer is one of a thermoplastic polymer and a UV light-curing polymer.

19. The all-solid-state battery of claim 14, wherein the second monomer is one of an inorganic electrolyte, a solid electrolyte and an inorganic solid electrolyte.

20. The all-solid-state battery of claim 14, wherein each of the first electrode and the second electrode includes a collector layer and an active substance.
